(19) United States
(12) Patent Application Publication
(10) Pub. No.: US 2024/0362303 A1
(43) Pub. Date: Oct. 31, 2024

(54) METHOD, DEVICE AND STORAGE MEDIA FOR MANAGING A LICENSE

(71) Applicant: XEPIC Technology (Shenzhen) Co., LTD., Shenzhen (CN)

(72) Inventors: Ning LI, Nanjing (CN); Yilong REN, Nanjing (CN); Xiang GAO, Shanghai (CN); Weijia LIU, Nanjing (CN)

(21) Appl. No.: 18/645,075

(22) Filed: Apr. 24, 2024

(30) Foreign Application Priority Data
Apr. 27, 2023 (CN) 202310469712.7

(51) Int. Cl. G06F 21/10

(52) U.S. Cl. CPC G06F 21/105

(57) ABSTRACT

A method for managing a license on a relay server connected to a cloud server and a license server includes sending to the cloud server a license request, corresponding to the license server and including a certificate of a user corresponding to the license server and an identifier of the license server, receiving, from the cloud server, a license corresponding to the license server and associated with a tool, distributing the license to the license server, obtaining, via the license server, a number of copies of the tool running on a worker server and working durations corresponding to the copies of the tool, and sending the number of the copies of the tool at running and the corresponding working durations to the cloud server. The license is not used to limit how many copies of the tool to be launched.

### CROSS REFERENCE TO RELATED APPLICATION

The application claims the benefits of priority to Chinese Application No. 2023104697127, filed Apr. 27, 2023, which is incorporated herein in its entirety.

### TECHNICAL FIELD

The disclosure relates to the field of computers, and in particular, to a method, device and storage medium for managing a license.

### BACKGROUND

In recent years, as the scale of a chip design has increased, local computing power may not meet the demands during the verification process of the chip design. In addition, the verification process usually involves a plurality of tools, such as a software simulator, a formal verification tool, and a hardware emulator (including a prototype verification device). A completed chip design can involve more tools.

Therefore, in the chip design industry, on the one hand, there is a shortage of computing resources for some tools during certain periods of time, and on the other hand, there are situations where some tools cannot fully utilize computing resources because the tool chain is too long.

Therefore, providing EDA (Electronic Design Automation) tools on the cloud as cloud computing resources has become a feasible solution to solve the above problems.

### SUMMARY

In accordance with the disclosure, there is provided a method, an electronic device, and a storage medium for managing a license.

A first aspect of the present disclosure provides a method for managing a license on a relay server connected to a cloud server and a license server, the method comprising: sending a license request corresponding to the license server to the cloud server, wherein the license request includes a certificate of a user corresponding to the license server and an identifier of the license server, and the license server and the relay server are managed by the user; receiving a license corresponding to the license server from the cloud server; distributing the license to the license server, wherein the license is associated with a tool, and the license is not used to limit how many copies of the tool to be launched; obtaining, via the license server, a number of copies of the tool running on a worker server and working durations corresponding to the copies of the tool; and sending the number of the copies of the tool at running and the corresponding working durations to the cloud server.

In some embodiments, receiving the license corresponding to the license server from the cloud server comprises: receiving an updated license from the cloud server.

In some embodiments, receiving the updated license from the cloud server comprises: periodically receiving the updated license from the cloud server, wherein the updated license includes an updated validity period.

In some embodiments, the tool is a first tool; the license is also associated with a second tool, and validity periods of the first tool and the second tool equal the validity period of the license; and the validity period of the license is less than or equal to 24 hours.

In some embodiments, the license comprises a first sub-license and a second sub-license, the first sub-license is associated with the first tool, and the second sub-license is associated with the second tool, and the license server is configured to: in response to a check-out request of the user for launching one or more copies of the first tool, check out one or more tokens from the first sub-license and record check-out time for the one or more copies of the first tool; in response to a check-in request of the worker server for ending the one or more copies of the first tool, check in the one or more tokens to the first sub-license and record check-in time for the one or more copies of the first tool; and send a number of the one or more copies of the first tool, the check-out time, and the check-in time to the relay server.

In some embodiments, the method further comprises: determining cost of using the tool according to the number of the copies of the tool at running and the corresponding working duration.

A second aspect of the present disclosure provides a method for managing a license on a license server connected to a relay server and at least one worker server, comprising: receiving a request from a user to use a tool to perform a verification work, wherein the license is associated with the tool, and the license is not used to limit how many copies of the tool to be launched by the at least one worker server; checking out, from the license, a certain of tokens corresponding to the request to the at least one worker server, wherein the tokens are used to launch the tool; in response to completion of the verification work, checking in the first number of tokens to the license; and sending the certain number, check-out time and check-in time of the tool to the relay server; wherein the license has a given validity period, and the certain number is determined merely by the request.

In some embodiments, the tool is a first tool; the license comprises a first sub-license and a second sub-license, the first sub-license is associated with the first tool, and the second sub-license is associated with a second tool, and validity periods of the first tool and the second tool equal the validity period of the license.

A third aspect of the present disclosure provides a method for managing a license on a cloud server connected to a relay serve, comprising: receiving a license request corresponding to a license server, wherein the license request comprises a certificate of a user corresponding to the license server and an identifier of the license server, and the license server and the relay server are managed by the user; sending a license corresponding to the license request to the relay server, wherein the license is associated with a tool, the license is not used to limit how many copies of the tool to be launched, and the license server checks out a token from the license to a worker server for launching a certain number of copies of the tool corresponding to the license; and receiving the certain number of launched copies of the tool and the corresponding working durations from the relay server.

In some embodiments, the license has a given license validity period; and ending the license corresponding to the license request to the relay server comprises: periodically updating the license, wherein the updated license includes an updated validity period.

A fourth aspect of the present disclosure provides a device for managing a license. The device can comprise: a memory storing a set of instructions; and at least one processor configured to execute the set of instructions to cause the device to perform the methods according to the first to third aspects above.

A fifth aspect of the present disclosure provides a non-transitory computer readable medium that stores a set of instructions that are executable by at least one processor of a computer system to cause the computer system to perform the methods according to the first to third aspects above.

The method, the device and the storage medium provided by the present disclosure enable the license not to limit the number, nodes and usage time of a certain tool used by a user, but only to determine whether the user is a legal user and has the right to use the certain tool. The number, nodes and usage time of a certain tool used by a user is determined merely by the request of the user. In other words, provide tools to users based entirely on users' actual needs rather than the preset limits of the license.

### BRIEF DESCRIPTION OF THE DRAWINGS

To describe the technical solutions in the present disclosure more clearly, the following will briefly introduce the figures that need to be used in the embodiments. Obviously, the figures in the following description are merely exemplary, for those ordinary skilled in the field, without inventive work, other figures can be obtained based on these figures.

FIG. 1 illustrates a schematic diagram of an example computing device according to embodiments of the present disclosure.

FIG. 2 illustrates a schematic diagram of a cloud system according to embodiments of the present disclosure.

FIG. 3 illustrates a schematic diagram of an EDA computing system according to embodiments of the present disclosure.

FIG. 4 illustrates a schematic diagram of a conventional license management system.

FIG. 5 illustrates a schematic diagram of a license management system according to embodiments of the present disclosure.

FIG. 6 illustrates a schematic diagram showing the interaction between the cloud server, relay server, license server and work server according to embodiments of the present disclosure.

FIG. 7 illustrates a schematic diagram showing two licenses according to embodiments of the present disclosure.

FIG. 8 illustrates a flow chart of a method for managing a license on a relay server according to embodiments of the present disclosure.

FIG. 9 illustrates a flow chart of a method for managing a license on a license server according to embodiments of the present disclosure.

FIG. 10 illustrates a flow chart of a method for managing a license on a cloud server according to embodiments of the present disclosure.

### DETAILED DESCRIPTION

Exemplary embodiments will be described in detail herein, and examples thereof are shown in the accompanying drawings. In the following description involving the accompanying drawings, the same numerals in different accompanying drawings indicate the same or similar elements, unless specified otherwise. Implementations described in the following exemplary embodiments do not represent all implementations consistent with the disclosure. In contrast, they are merely examples of devices and methods consistent with some aspects of the disclosure as described in detail in the appended claims.

Terms in the disclosure are merely used for describing specific embodiments, rather than limiting the disclosure. Singular forms “a (an),” “said,” and “the” used in the present disclosure and the appended claims also include plural forms, unless clearly specified in the context that other meanings are denoted. It should be further understood that the term “and/or” used herein refers to and includes any or all possible combinations of one or more associated items listed.

It should be appreciated that, although terms such as “first,” “second,” and “third” may be used to describe various kinds of information in the disclosure, these kinds of information should not be limited by the terms. These terms are merely used to distinguish information of the same type from each other. For example, without departing from the scope of the disclosure, the first information may also be referred to as second information, and similarly, the second information may also be referred to as first information. Depending on the context, the word “if” used herein may be explained as “when . . . ,” “as . . . ,” or “in response to the determination.”

In the context of moving EDA tools to the cloud, a user can use a tool (software or hardware) in multiple threads. For example, for scenarios where software simulation can be performed in parallel, users can launch a plurality of simulation tools at the same time to perform the software simulation in parallel.

The use of a tool often requires checking the license to determine whether the user is authorized to use the tool and for how long. The conventional license management method is a management method directed to offline servers, and can no longer meet the needs of EDA tools on the cloud. Therefore, providing a method and device for managing a license for the cloud tools is a technical problem that needs to be solved urgently in this field.

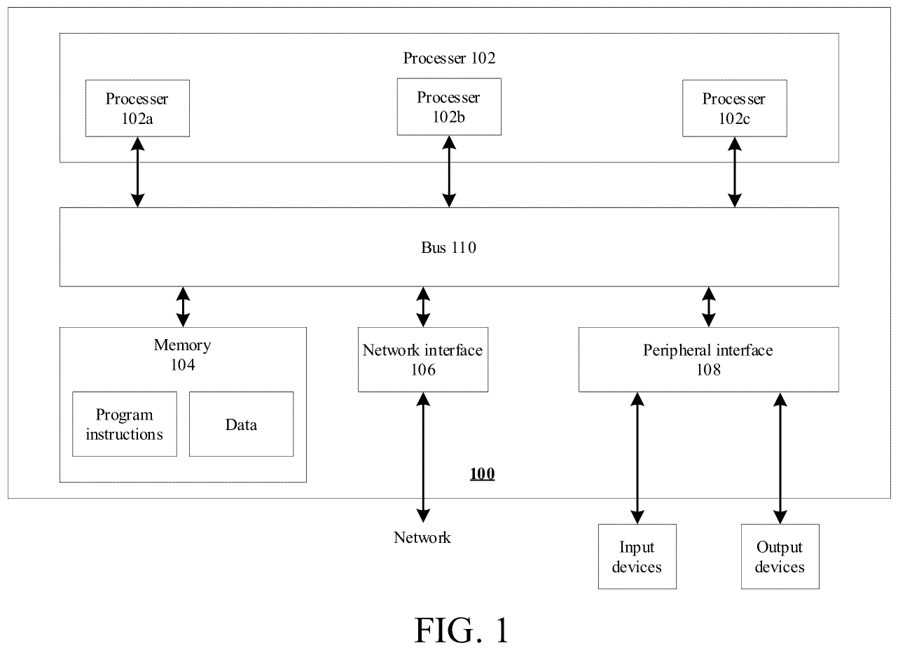

FIG. 1 illustrates a schematic diagram of an example computing device 100 according to embodiments of the present disclosure. As shown in FIG. 1, the computing device 100 can include a processor 102, a memory 104, a network interface 106, a peripheral interface 108, and a bus 110. The processor 102, the memory 104, the network interface 106, and the peripheral interface 108 are connected to each other within the computing device 100 through the bus 110.

The processor 102 can be a central processing unit (CPU), an image processor, a neural network processor (NPU), a micro control unit (MCU), a programmable logical device, a digital signal processor (DSP), an application specific integrated circuit (ASIC), or one or more integrated circuits. The processor 102 can perform functions related to the techniques described in the disclosure. In some embodiments, the processor 102 can also include a plurality of processors integrated into a single logical component. As shown in FIG. 1, the processor 102 can include a plurality of processors 102a, 102b, and 102c.

The memory 104 can be configured to store data (e.g., instructions, lists of TCL objects, computer codes, properties of objects and values of properties, etc.). As shown in FIG. 1, the data stored in the memory can include program instructions (e.g., program instructions for implementing the method of displaying the target module of the logical system design of the present disclosure) and data to be processed (e.g., the memory can store temporary code generated during the compilation process, object attributes and attribute values, etc.). The processor 102 can also access program instructions and data stored in memory and execute the program instructions to operate on data to be processed. The memory 104 can include volatile storage or non-volatile storage. In some embodiments, the memory 104 can include random access memory (RAM), read only memory (ROM), optical disk, magnetic disk, hard drive, solid state disk (SSD), flash memory, memory stick, and the like.

The network interface 106 can be configured to provide communication with other external devices to the computing device 100 via the network. The network can be any wired or wireless network capable of transmitting and receiving data. For example, the network can be a wired network, a local wireless network (e.g., Bluetooth, WiFi, near field communication (NFC), etc.), a cellular network, the Internet, or a combination of the above. It is understood that the type of network is not limited to the specific examples above. In some embodiments, the network interface 106 can include any combination of any number of network interface controllers (NICs), radio frequency modules, transceivers, modems, routers, gateways, adapters, cellular network chips, and the like.

The peripheral interface 108 can be configured to connect the computing device 100 with one or more peripheral devices to enable information input or output. For example, the peripheral devices can include input devices such as keyboards, mice, touch pads, touch screens, microphones, and various sensors, as well as output devices such as displays, speakers, vibrators, and indicator lights.

The bus 110 can be configured to transport information between various components of the computing device 100 (e.g., the processor 102, the memory 104, the network interface 106, and the peripheral interface 108), such as an internal bus (e.g., the processor-memory bus), an external bus (USB port, PCI-E bus), etc.

It should be noted that although the above computing device architecture only shows the processor 102, the memory 104, the network interface 106, the peripheral interface 108 and the bus 110, during the specific implementation, the computing device architecture can also include other components necessary for normal operation. In addition, those skilled in the art can understand that the above computing device architecture can also include only the components necessary to implement the embodiments of the present disclosure but not all components shown in FIG. 1.

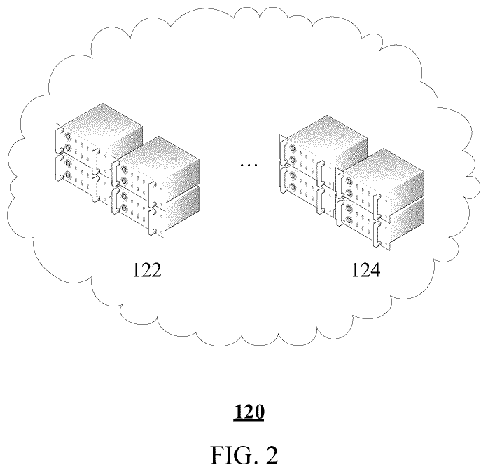

FIG. 2 illustrates a schematic diagram of a cloud system 120 according to embodiments of the present disclosure.

As shown in FIG. 2, the cloud system 120 can include a plurality of the cloud servers (e.g., 122, 124). These cloud servers can be, for example, the computing device 100 shown in FIG. 1 or computers provided by the cloud computing servers. The cloud servers (122, 124) can provide computing resources to users, while the cloud servers can also serve as a host of hardware emulation resources to invoke a plurality of hardware emulation tools in the cloud system 120. It is appreciated that the plurality of hardware emulation tools can be connected to a plurality of hosts, and FIG. 2 is only an example.

The plurality of hardware emulation tools can include a hardware emulator (emulator), a prototype verification tool, and peripheral cards (for example, various daughter cards, etc.) connected to the hardware emulator or the prototype verification tool. It is be appreciated that the plurality of hardware emulation tools can include more hardware resources and are not limited to the above examples.

The cloud system 120 can be used to provide verification cloud computing resources. Therefore, the cloud system 120 is also referred to as the cloud computing resource 120 in the present disclosure.

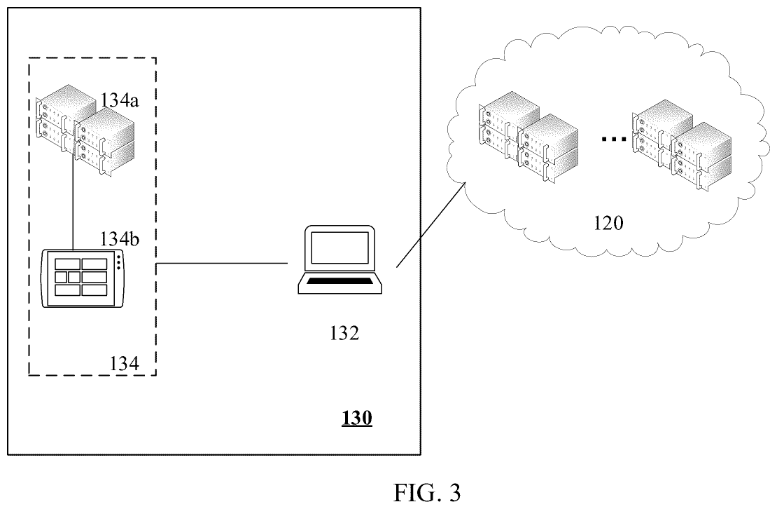

FIG. 3 illustrates a schematic diagram of an EDA computing system 130 according to embodiments of the present disclosure.

The EDA computing system 130 of the present disclosure can be a local computing system, and include a computing device 132. In some embodiments, the EDA computing system 130 can also include local computing resources 134.

The computing device 132 can be the computing device 100 as shown in FIG. 1. The computing device 132 cam provide a resource manager to the user and provide an interface connected to the cloud system 120 and an interface connected to the computing resources 134a and 134b. The computing device 132 as a local host can also allocate different computing tasks to the cloud or locally accordingly. A local resource, “local,” or “locally” refers to computer(s) that are deployed within a computer room of a user (e.g., an IC design company).

In some embodiments, the local computing resources 134 can include at least one of the server 134a or the hardware verification tool 134b. A plurality of EDA tasks can be executed partially on the cloud computing resource 120 and partially on the local computing resources 134. It can be appreciated that the plurality of EDA tasks can also be executed only on the cloud computing resource 120 or only on the local computing resources 134.

The server 134a can be the host 100 as shown in FIG. 1. In some embodiments, the server 134a can run at least one EDA software tool (e.g., a software simulator, a formal verification tool, etc.). The server 134a can also serve as the host of the hardware verification tool 134b, and be used to cooperate with the hardware verification tool 134b to execute the verification tasks and read the verification results.

The hardware verification tool 134b can exemplarily include hardware verification tools, such as a prototype verification board, a hardware emulator, and the like.

Although only a limited number of the local computing resources 134 are presented in FIG. 3, those skilled in the art can understand that any number of the local computing resources 134 can be provided according to actual needs. That is, there can be a plurality of servers 134a and a plurality of hardware verification tools 134b. The server 134a and the hardware verification tool 134b are not necessarily provided in a one-to-one correspondence. For example, one server 134a can be connected with a plurality of hardware verification tools.

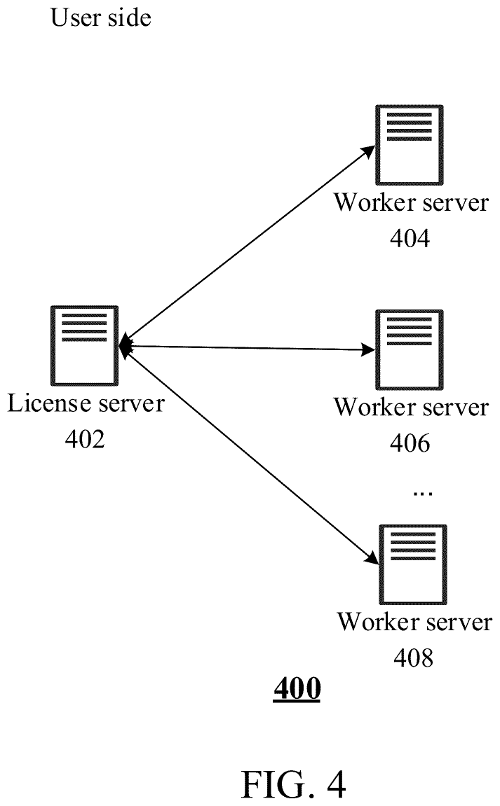

FIG. 4 illustrates a schematic diagram of a conventional license management system 400.

The conventional license management system 400 can typically include license servers and worker servers.

As shown in FIG. 4, on the user side, a license server 402 is connected to a plurality of worker servers (e.g., 404, 406, and 408). In other words, the license server 402 and the plurality of the worker servers are managed by the user. The license server 402 can store licenses for tool (e.g., the GalaxSim simulation tool). A specified number of copies of the tool can be allowed to be launched and the validity period of the copies of the tool is limited (i.e., the expiration date is set). Each license can launch a copy of the tool. That is, if the user wants more copies than the specified number to be launched, the user will have to purchase additional licenses. The validity period of the license is usually several months or years, and occasionally unlimited. When the user purchases a plurality of different tools at a same time, a plurality of different licenses can exist on the license server 402. The licenses for different tools can have different expiration dates due to the date of purchase. In some embodiments, one server can be both a license server and a worker server.

To limit the number of copies of the tool that can be launched, a variable can be set in the license of the tool to specify the number (e.g., 2) of copies that can be launched. For example, when a worker server (e.g., 404) requests the license server 402 to launch the GalaxSim tool, the license server 402 can decrease the value of the variable by one (e.g., from 2 to 1). The operation of decreasing the launchable number of copies is also called “check in.” When both the worker server 404 and the worker server 406 request to launch the GalaxSim tool, the license server 402 can decrease the value of this variable from 1 to 0. In this way, when another worker server 408 requests to launch the GalaxSim tool, the license server 402 can check the variable and deny the request of the worker server 408 to launch the GalaxSim tool in response to the variable having a value of zero. On the other hand, when the worker server 404 logs out of the GalaxSim tool, the license server 402 can increase the value of this variable by one (e.g., from 0 to 1). The operation of increasing the launchable number of copies is also called “check out.”

It can be seen that tool suppliers can only sell tools on a per-unit basis under the above license management method. Users can only use the tool according to the number of purchased licenses. This results in a lack of flexibility in using the tool. For example, a fixed number of licenses cannot temporarily provide more capacity when a user happens to need more copies. When users use the tool regularly, a fixed number of licenses can lead to unused license(s), making it impossible to fully use the tool that the user purchased. On the other hand, in the field of EDA, due to the complexity and diversity of tools, a user's chip design project usually involves a plurality of tools. The existing one-tool-one-license approach can complicate management as the number of licenses increases, especially when different tools have different expiration dates.

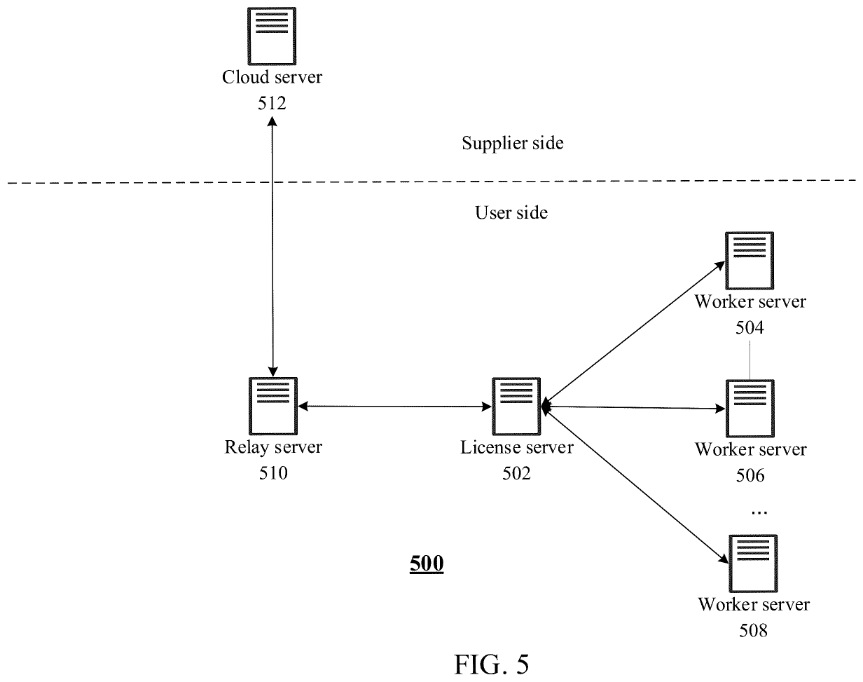

FIG. 5 illustrates a schematic diagram of a license management system 500 according to embodiments of the present disclosure.

As shown in FIG. 5, in addition to the license server 502 and a plurality of worker servers on the user side, the license management system 500 also deploys a cloud server 512 on the supplier side, and an additional relay server 510 is deployed on the user side. It can be appreciated that the cloud server only refers to a remote server where the server 512 is away from the user side. In fact, the license server 502, a plurality of worker servers 504-508, the cloud server 512, and the relay server 510 can be deployed on a local server, a private cloud, or a public cloud.

The cloud server 512 can be connected to the relay server 510. The relay server 510 can be connected to the license server 502 via a proprietary communication line (e.g., VPN).

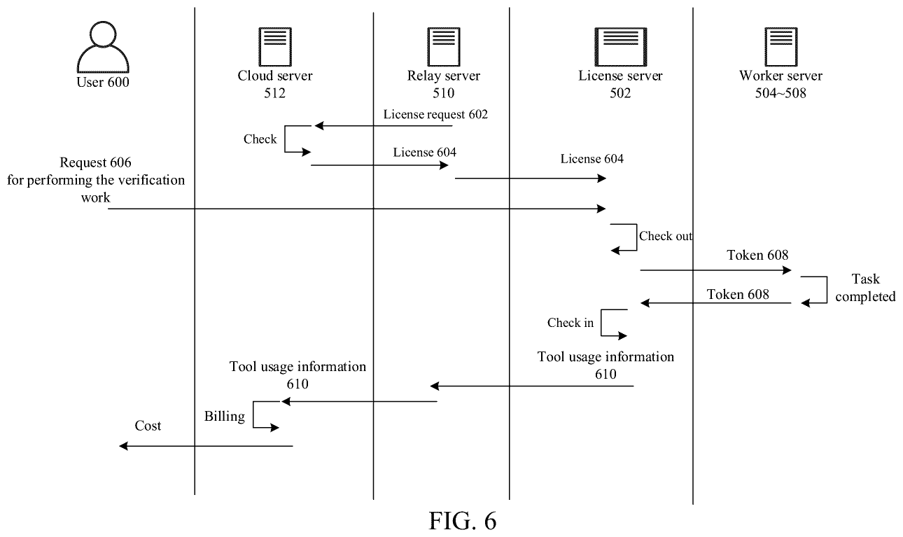

FIG. 6 illustrates a schematic diagram showing the interaction between the cloud server, relay server, license server and work server according to embodiments of the present disclosure.

As shown in FIG. 6, the cloud server 512 receives a license request 602 corresponding to the license server 502 from the relay server 510. In some embodiments, the relay server 510 can periodically send the license request 602 to the cloud server 512 to obtain the latest license for a user. To verify the user's identity, the relay server 510 can obtain the identifier of the license server 502 (e.g., the MAC address of the license server 502). In addition to the identifier of the license server 502, the relay server 510 can also provide a certificate of the user to the cloud server 512. The certificate can be provided by the tool suppliers and is a unique identifier for the user. The license request 602 can include the certificate of the user and the identifier of the license server 502. In some embodiments, the tool can be an EDA tool.

The cloud server 512 can store information corresponding to the certificate of the user and the identifier of the license server 502 associated with the user (e.g., managed by the user) in advance. In this way, when the cloud server 512 receives the license request 602, the cloud server 512 can determine (e.g., check) whether the user and the license server 502 are legal based on the stored information (that is, checking whether the license request is legal). After the cloud server 512 confirms that the license request is legal, the cloud server 512 can send the license 604 corresponding to the license request to the relay server 510. That is, the relay server 510 can receive the license 604 from the cloud server 512.

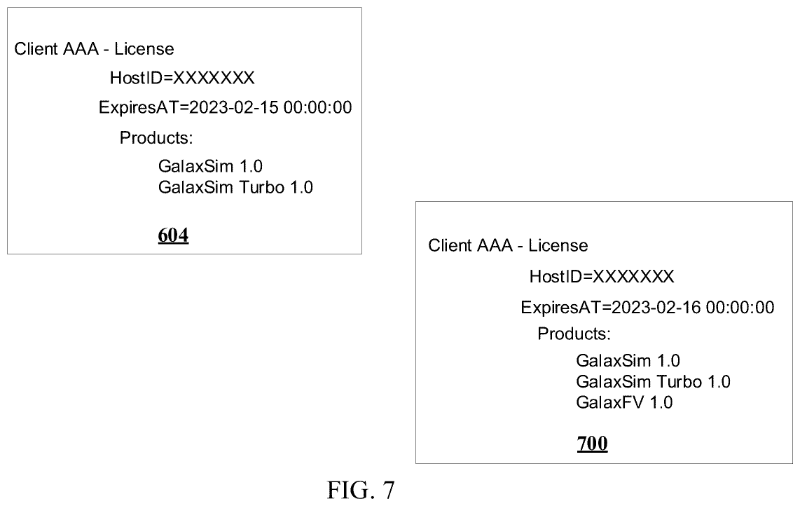

FIG. 7 illustrates a schematic diagram showing licenses 604 and 700 according to embodiments of the present disclosure.

The license 604 can be a data file, and can at least include information of the license server, the license expiration date, and the licensed tools.

The information of the license server can include the identifier of the license server (e.g., MAC address). Thus, other than the licensed license server, any other server cannot launch any tools even if it has a copy of the license 604.

The license expiration date specifies the expiration date of the license. Different from the conventional licenses, which often have longer license validity period (e.g., from months to years), the license validity period of the license 604 is typically short, often measured in hours or days. For example, in one embodiment, the validity period of the license 604 is 24 hours, and accordingly, the expiration date is set to 0:00:00 on Feb. 15, 2023 (as in the license 604 shown in FIG. 7). This also requires the relay server 510 to request a new license before the license 604 expires. In some embodiments, the relay server 510 requests a new license at a fixed period (e.g., 10 minutes). Two hours before the license expires, the cloud server 512 updates the license validity period to 0:00:00 on Feb. 16, 2023 (as in the license 700 shown in FIG. 7). Therefore, an updated license includes an updated validity period.

The licensed tools can be a list recording the name and version of one or more licensed tools. Different from the conventional licenses, the license 604 can be associated with a plurality of tools (for example, GalaxSim or GalaxSim Turbo) and does not limit the number of copies for each tool. This allows the user to invoke any number of copies of the above tools according to actual needs. In other words, the license 604 is not used to limit the number of copies that a worker server can run. Restricted by the capability of a working server, a number of copies of a tool running on the working server cannot exceed the capability of the working server. Therefore, the term “the license 604 is not used to limit the number of copies that a worker server can run” means that the number of copies of a tool that the license 604 allows the working server to run can exceed the running capability of the working server.

In some embodiments, the license 604 assigns a variable to each tool. The value of the variable indicates the number of the copies of the tool that can currently be launched. As mentioned above, the value of the variable can be set to a large number so that the worker server can launch copies of the tool more than the worker server can launch. At the same time, the variable can also be used to record the check-out and check-in of the tool, so that the usage of the tool can be counted. For example, the initial value of the variable is 999, and each time the tool is used, the variable is decreased by one.

In other embodiments, the license 604 assigns a variable to each tool. The variable is only used to record the check-out and check-in of the tool, so that the usage of the tool can be counted. It is appreciated that, in these embodiments, the variable does not limit the number of the available copies of the tool.

The licensed tools can be determined by the tool supplier. The license 604 can be generated by the cloud server 512. For example, when a user purchases a new tool (e.g., GalaxFV), the cloud server 512 can generate a new license 700 to include the new tool, and eventually synchronize the new license 700 to the user. Each tool licensed under the license 604 or 700 can also be referred to as a sub-license.

Although the license 604 is exemplified in the form of a license file here, it is appreciated that, in some embodiments, a license can also be distributed separately for each tool. In these embodiments, the collection of these licenses can be considered as the license 604, and each individual license can be considered as a sub-license. It can be appreciated that the information is the same for the plurality of individual sub-licenses above, except for the licensed tools.

Returning to FIG. 6, after receiving a license (e.g., the license 604), the relay server 510 can distribute the license 604 to the license server 502. The license 604 has a given validity period. It is appreciated that the validity period is applicable to all tools corresponding to the license 604 (e.g., Galaxsim, GalaxSim Turbo and GalaxFV in FIG. 7).

The relay server 510 can request the cloud server 512 to update the license 604 regularly or irregularly. In some embodiments, the relay server 510 requests the cloud server 512 to update the license 604 every 10 minutes.

In this way, when the user 600 needs to launch a tool (e.g., GalaxSim or GalaxSim Turbo) to perform a verification work, the user 600 can send a request 606 for performing the verification work to the license server 502. The verification work can include a command line that launches a copy of the tool to perform the verification work, or a verification work issued by the cloud manager. In some embodiments, the request 606 also includes the number of copies of the tool that need to be launched (e.g., ten copies of GalaxSim need to be launched simultaneously). Compared with conventional licenses limiting the number of copies of the tool to the number of licenses purchased by the user, the licenses in the embodiments of the present disclosure does not limit the number of copies of the tool that the user can launch and nodes at which the copies of the tool work. The number of copies of certain tool is determined only by the user's request 606.

Based on the request 606 for launching the tool, the license server 502 can determine whether the user's license 604 includes the authorization for the tool. If the license 604 includes the authorization for the tool, the license server 502 can check out the number of copies of the tool corresponding to the request 606 to the worker servers 504-508. The license server 502 can also record the check-out time and the check-out number of each copy of the tool. In some embodiments, the license server 502 can check out one or more tokens 608 from the license 604 according to the request 606 and send them to the worker servers 504-508. The working servers 504˜508 can launch the corresponding tools according to the tokens.

The worker servers 504˜508 can launch the tools accordingly and perform the verification task. After the verification task is completed, the worker servers 504-508 can send the token 608 back to the license server 502. The license server 502 can check in the token 608 back to the license 604. The license server 502 records check-in time and check-in number of copies for each tool accordingly.

Data generated by the worker servers 504-508 executing the request 606 can be stored in a database. The database can be cloud-based or local. The user 600 can check the results of the verification work by accessing the corresponding database. Since how the user checks the results of the verification work is not the focus of this disclosure, it will not be described again here.

Based on the check-in time and check-out time of each tool, the license server 502 can calculate the working hours of each tool. Combined with the number of tools, the license server 502 can send the tool usage information 610 (including the working time and the number of tools) to the relay server 510, and the relay server 510 sends the tool usage information 610 to the cloud server 512. Based on the tool usage information 610, the cloud server 512 can determine the cost of the user 600 for performing the request 606.

Compared with conventional licenses, the licenses in embodiments of this disclosure are not used to limit the number, nodes, and usage time of use of a certain tool, but only determine whether the user is a legal user and has the right to use the certain tool. The number, nodes, and usage time of using the certain tool by the user is determined only by the user's request 606. That is, tools are provided to users based entirely on their actual needs rather than on the preset limits of the licenses.

Since the licenses in embodiments of the disclosure only determine whether the user is a legal user and whether the user has the right to use a certain tool, to avoid license abuse, embodiments of the disclosure binds the identifier of the license server to the licenses to ensure that the licenses are only available on the certain license server. At the same time, a license only has a short validity period. To keep the license valid for a longer period, the relay server has to maintain a connection to the cloud server and continuously request license updates. In this way, once there is an abnormality in the license or worker server on the user side, the cloud server on the supplier side can stop the license update, thereby limiting the use of the license to a short validity period.

By setting up the relay server, the license server and the worker server on the user side can be isolated from the external network, thereby achieving isolation from the external network while maintaining communication with the cloud server.

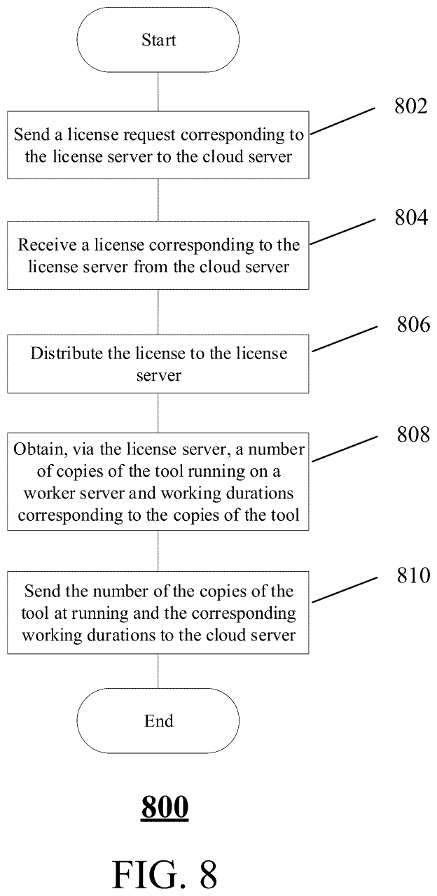

FIG. 8 illustrates a flow chart of a method 800 for managing a license on a relay server according to embodiments of the present disclosure. The method 800 can be performed, for example, by the computing device 100 shown in FIG. 1, and more specifically, by the relay server 510 of FIG. 5. The relay server 510 is connected to the cloud server 512 and the license server 502. The license is a license used to authorize the operation of software and hardware tools. The software and hardware tools mentioned above can be EDA tools for chip design. Although this disclosure takes a certain EDA tool as an example, those skilled in the art can understand that other types of software or hardware tools can use the method of this disclosure. The method 800 can include the following steps.

In step 802, the relay server 510 can send a license request (e.g., the license request 602 of FIG. 6) corresponding to the license server (e.g., the license server 502 of FIG. 6) to the cloud server (e.g., the cloud server 512 of FIG. 6), wherein the license request includes a certificate of a user (e.g., the user 600 of FIG. 6) corresponding to the license server and an identifier of the license server. And the license server and the relay server are managed by the user.

In step 804, the relay server 510 can receive a license (e.g., the license 604 of FIG. 6) corresponding to the license server from the cloud server.

In step 806, the relay server 510 can distribute the license to the license server, wherein the license is associated with a tool (e.g., GalaxSim of FIG. 7), and the license is not used to limit how many copies of the tool to be launched. The license is also associated with a second tool.

In some embodiments, the tool is a first tool, and the license is also associated with a second tool. The license further comprises a first sub-license and a second sub-license. The first sub-license is associated with the first tool, the second sub-license is associated with the second tool. And the license server is configured to: in response to the user's check-out request for launching one or more copies of the first tool, check out one or more tokens from the first sub-license and record check-out time for the one or more copies of the first tool; in response to the worker server's check-in request for ending the one or more copies of the first tool, check in the one or more tokens to the first sub-license and record check-in time for the one or more copies of the first tool; and send the number of the one or more copies of the first tool, the check-out time, and the check-in time to the relay server.

In step 808, the relay server 510 can obtain a number of copies of the tool running on a worker server and corresponding working duration via the license server.

In step 810, the relay server 510 can send the number of the copies of the tool running on the worker server and the corresponding working duration to the cloud server. The license includes a given license validity period. Validity periods of the first tool and the second tool equal the validity period of the license. In some embodiments, the validity period of the license is less than or equal to 24 hours.

In some embodiments, receiving the license corresponding to the license server from the cloud server comprises periodically receiving an updated license from the cloud server. As mentioned above, the license can be updated, and the updated license can include the updated validity period and a new tool being licensed.

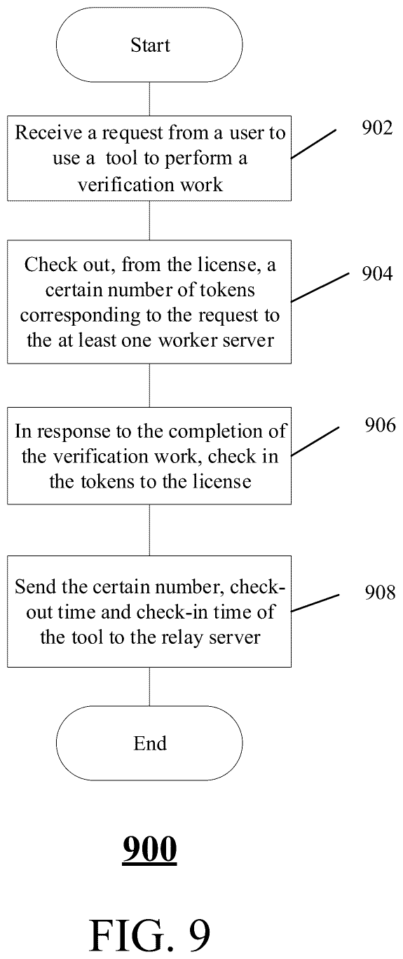

FIG. 9 illustrates a flow chart of a method 900 for managing a license on a license server according to embodiments of the present disclosure. The method 900 can be performed, for example, by the computing device 100 shown in FIG. 1, and more specifically, by the license server 502 of FIG. 5. The license server 502 is connected to the relay server 510 and at least one worker server (e.g., 504-508). The license is a license used to authorize the operation of software and hardware tools. The software and hardware tools mentioned above can be EDA tools for chip design. Although this disclosure takes a certain EDA tool as an example, those skilled in the art can understand that other types of software or hardware tools can use the method of this disclosure. The method 900 can include the following steps.

In step 902, the license server 502 can receive a request from a user (e.g., the user 600 of FIG. 6) to use a tool (e.g., GalaxSim) to perform a verification work, wherein the license is associated with the tool, and the license is not used to limit how many copies of the tool to be launched on the at least one worker server.

In step 904, the license server 502 can check out a certain number of tokens (e.g., token 608) corresponding to the request to the at least one worker server, wherein the tokens are used to launch the tool.

In step 906, in response to completion of the verification work (e.g., receiving the returned token 608), the license server 502 can check in the tokens to the license.

In step 908, the license server 502 can send the certain number, check-out time and check-in time of the tool to the relay server, wherein, the license has a given validity period, and the certain number is determined merely by the request.

The tool is a first tool, and the license is also associated with a second tool. The license further comprises a first sub-license and a second sub-license. The first sub-license is associated with the first tool, the second sub-license is associated with a second tool, and validity periods of the first tool and the second tool equal the validity period of license.

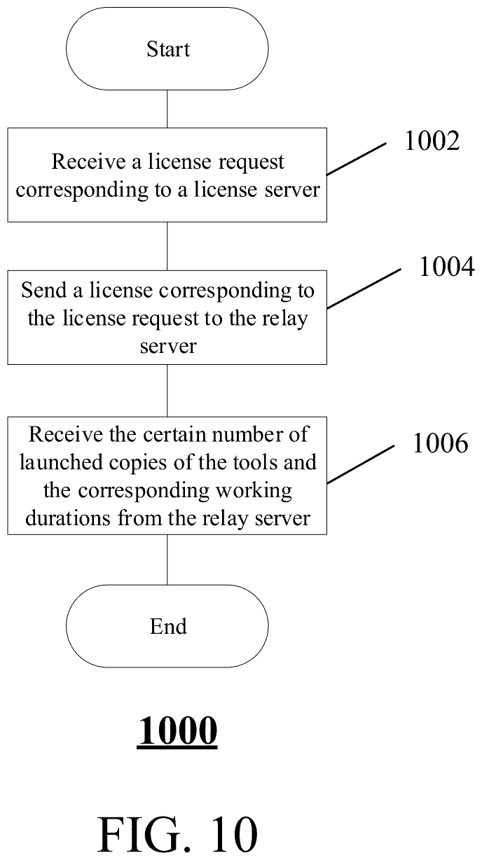

FIG. 10 illustrates a flow chart of a method 1000 for managing a license on a cloud server according to embodiments of the present disclosure. The method 1000 can be performed, for example, by the computing device 100 shown in FIG. 1, and more specifically, by the cloud server 512 of FIG. 5. The cloud server 512 is connected to the relay server 510. The license is the license used to authorize the operation of software and hardware tools. The software and hardware tools mentioned above can be EDA tools for chip design. Although this disclosure takes a certain EDA tool as an example, those skilled in the art can understand that other types of software or hardware tools can use the method of this disclosure. The method 1000 can include the following steps.

In step 1002, the cloud server 512 can receive a license request (e.g., the license request 602 of FIG. 6) corresponding to a license server (e.g., the license server 502 of FIG. 6), wherein the license request comprises a certificate of a user corresponding to the license server and an identifier of the license server, and the license server and the relay server are managed by the user.

In step 1004, the cloud server 512 can send ae license corresponding to the license request to the relay server, wherein the license is associated with a tool. The license is not used to limit how many copies of the tool to be launched, and the license server checks out a token from the license to a worker server for launching a certain number of copies of the tool corresponding to the license. Sending the license corresponding to the license request to the relay server further comprises: periodically updating the license. The updated license can include an updated validity period.

In step 1006, the cloud server 512 can receive the certain number of copies of the tool at running and the corresponding working durations from the relay server.

Embodiments of the present disclosure also provides a computing device (e.g., computing device 100 of FIG. 1) for managing a license. The device can comprise: a memory for storing a set of instructions; and at least one processor configured to execute the set of instructions to cause the computing device to perform.

Embodiments of the present disclosure also provides a non-transitory computer readable medium that stores a set of instructions that is executable by at least one processor of a computer system to cause the computer system to perform the first to third above methods for managing a license.

Compared with conventional licenses, the licenses in the embodiment of this disclosure are not used to limit the number, nodes, and usage time of use of a certain tool, but only determine whether the user is a legal user and has the right to use the certain tool. The number, nodes, and usage time of use of a certain tool by the user is determined only by the user's request 606. That is, tools are provided to users based entirely on their actual needs rather than on the preset limits of the licenses.

Since the licenses in this embodiment of the disclosure only determine whether the user is a legal user and has the right to use a certain tool, to avoid license abuse, this embodiment of the disclosure binds the identifier of the license server to the licenses to ensure that the licenses are only available on the certain license server. At the same time, the licenses only have short validity periods. To keep the license valid for a longer period, the relay server needs to maintain a connection to the cloud server and continuously request license updates. In this way, once there is an abnormality in the license or worker server on the user side, the cloud server on the supplier side can stop the license update, thereby limiting the use of the license to a short validity period.

By setting up the relay server, the license server and the worker server on the user side can be isolated from the external network, thereby achieving isolation from the external network while maintaining communication with the cloud server.

Those skilled in the art can easily derive other embodiments of the present disclosure after considering and practicing the above disclosure. The present disclosure is aimed at covering any variations, use or adaptive changes of the present disclosure, and the variations, use or adaptive changes conform to the general principle of the present disclosure and include common knowledge or common technical means in the technical field not disclosed in the present disclosure. The specification and embodiments are merely regarded as exemplary, and the scope and spirit of the present disclosure are defined by the accompanied claims.

It should be appreciated that the present disclosure is not limited to the exact structure described above and illustrated in the drawings, and various modifications and changes can be made without departing from the scope thereof. The scope of the invention is only limited by the appended claims.

What is claimed is:

1. A method for managing a license on a relay server connected to a cloud server and a license server, the method comprising:
sending a license request corresponding to the license server to the cloud server, wherein the license request includes a certificate of a user corresponding to the license server and an identifier of the license server, and the license server and the relay server are managed by the user;
receiving a license corresponding to the license server from the cloud server;
distributing the license to the license server, wherein the license is associated with a tool, and the license is not used to limit how many copies of the tool to be launched;
obtaining, via the license server, a number of copies of the tool running on a worker server and working durations corresponding to the copies of the tool; and
sending the number of the copies of the tool at running and the corresponding working durations to the cloud server.

2. The method according to claim 1, wherein receiving the license corresponding to the license server from the cloud server comprises:
receiving an updated license from the cloud server.

3. The method according to claim 2, wherein receiving the updated license from the cloud server comprises:
periodically receiving the updated license from the cloud server, wherein the updated license includes an updated validity period.

4. The method according to claim 1, wherein:
the tool is a first tool;
the license is also associated with a second tool, and validity periods of the first tool and the second tool equal a validity period of the license; and
the validity period of the license is less than or equal to 24 hours.

5. The method according to claim 4, wherein:
the license comprises a first sub-license and a second sub-license, the first sub-license is associated with the first tool, and the second sub-license is associated with the second tool; and
the license server is configured to:
in response to a check-out request of the user for launching one or more copies of the first tool, check out one or more tokens from the first sub-license and record check-out time for the one or more copies of the first tool;
in response to a check-in request of the worker server for ending the one or more copies of the first tool, check in the one or more tokens to the first sub-license and record check-in time for the one or more copies of the first tool; and
send a number of the one or more copies of the first tool, the check-out time, and the check-in time to the relay server.

6. The method according to claim 1, further comprising:
determining cost of using the tool according to the number of the copies of the tool at running and the corresponding working durations.

7. A device for managing a license on a relay server connected to a cloud server and a license server, comprising:
a memory storing a set of instructions; and
at least one processor configured to execute the set of instructions to cause the device to perform the method according to claim 1.

8. The device according to claim 7, wherein, in receiving the license corresponding to the license server from the cloud server, the at least one processor is configured to execute the set of instructions to cause the device to receive an updated license from the cloud server.

9. The device according to claim 8, wherein, in receiving the updated license from the cloud server, the at least one processor is configured to execute the set of instructions to cause the device to periodically receive the updated license from the cloud server, wherein the updated license includes an updated validity period.

10. The device according to claim 7, wherein:
the tool is a first tool;
the license is also associated with a second tool, and validity periods of the first tool and the second tool equal a validity period of the license; and
the validity period of the license is less than or equal to 24 hours.

11. The device according to claim 10, wherein:
the license comprises a first sub-license and a second sub-license, the first sub-license is associated with the first tool, and the second sub-license is associated with the second tool; and
the license server is configured to:
in response to a check-out request of the user for launching one or more copies of the first tool, check out one or more tokens from the first sub-license and record check-out time for the one or more copies of the first tool;
in response to a check-in request of the worker server for ending the one or more copies of the first tool, check in the one or more tokens to the first sub-license and record check-in time for the one or more copies of the first tool; and
send a number of the one or more copies of the first tool, the check-out time, and the check-in time to the relay server.

12. The device according to claim 11, wherein the at least one processor is further configured to execute the set of instructions to:
determine cost of using the tool according to the number of the copies of the tool at running and the corresponding working durations.

13. A non-transitory computer readable medium that stores a set of instructions that are executable by at least one processor of a computer system to cause the computer system to perform the method according to claim 1.

14. A method for managing a license on a license server connected to a relay server and at least one worker server, comprising:
receiving a request from a user to use a tool to perform a verification work, wherein the license is associated with the tool, and the license is not used to limit how many copies of the tool to be launched by the at least one worker server;
checking out, from the license, a certain number of tokens corresponding to the request to the at least one worker server, wherein the tokens are used to launch the tool;
in response to completion of the verification work, checking in the tokens to the license; and
sending the certain number, check-out time and check-in time of the tool to the relay server;
wherein the license has a given validity period, and the certain number is determined merely by the request.

15. The method according to claim 14, wherein:
the tool is a first tool;
the license comprises a first sub-license and a second sub-license, the first sub-license is associated with the first tool, and the second sub-license is associated with a second tool; and
validity periods of the first tool and the second tool equal the validity period of the license.

16. A method for managing a license on a cloud server connected to a relay serve, comprising:
receiving a license request corresponding to a license server, wherein the license request comprises a certificate of a user corresponding to the license server and an identifier of the license server, and the license server and the relay server are managed by the user;
sending a license corresponding to the license request to the relay server, wherein the license is associated with a tool, the license is not used to limit how many copies of the tool to be launched, and the license server checks out a token from the license to a worker server for launching a certain number of copies of the tool corresponding to the license; and
receiving the certain number of launched copies of the tool and the corresponding working durations from the relay server.

17. The method according to claim 16, wherein:
the license has a given license validity period; and
sending the license corresponding to the license request to the relay server comprises periodically updating the license, wherein the updated license includes an updated validity period.
